(19) United States
(12) Patent Application Publication
(10) Pub. No.: US 2013/0186367 A1
(43) Pub. Date: Jul. 25, 2013

(54) METHOD, CYLINDER, AND ENGINE WITH CENTRAL IGNITION SPARK POSITION

(71) Applicant: FRANZ J. LAIMBOECK, GOLETA, CA (US)

(72) Inventor: FRANZ J. LAIMBOECK, GOLETA, CA (US)

(73) Assignee: MAHLE KOENIG KOMMANDITGESELLSCHAFT GMBH & CO KG, RANKWEIL (AT)

(21) Appl. No.: 13/604,827

(22) Filed: Sep. 6, 2012

Related U.S. Application Data
(60) Provisional application No. 61/531,383, filed on Sep. 6, 2011.

(51) Int. Cl. F02B 5/00

(52) U.S. Cl. CPC F02B 5/00
USPC 123/305

(57) ABSTRACT

A method for the combustion of a fuel-air mixture present in the combustion chamber of an engine cylinder. At least a part of the fuel, in particular all of the fuel, is introduced immediately prior to the ignition time with a mean fuel droplet size of ≦20 μm, preferably ≦10 μm, as defined by the mean Sauter diameter, in the direction of at least one ignition path situated in the central region of the piston crown (4), and the fuel-air mixture is ignited by way of one or a number of successive ignition sparks.

### CROSS-REFERENCE TO RELATED APPLICATION

This application claims the benefit, under 35 U.S.C. §119(e), of provisional patent application No. 61/531,383 filed Sep. 6, 2011; the prior application is herewith incorporated by reference in its entirety.

### BACKGROUND OF THE INVENTION

### Field of the Invention

The invention relates to an ignition method for the combustion of a fuel-air mixture that is present in the combustion chamber of an engine cylinder. At least a part of the fuel, in particular all of the fuel, is introduced immediately before the ignition time with a mean fuel droplet size of ≦20 μm, preferably ≦10 μm, as defined by the mean Sauter diameter, in the direction of at least one ignition path, and the fuel-air mixture is ignited by means of one or a number of successive ignition sparks. The invention also relates to an engine cylinder having a piston and having at least one feed unit by way of which fuel or a fuel-air mixture is introduced into the combustion chamber of the cylinder

Engine cylinders of the generic type are known for example from Japanese publication JP 2009243366 A, from U.S. Patent Application Publication No. U.S. 2008/0135016 A1 or from U.S. Patent Application Publication No. U.S. 2009/0126669 A1.

### SUMMARY OF THE INVENTION

It is an aim of the invention to provide an engine cylinder for the combustion of fuel-air mixture which can be operated with the least possible exhaust gas, in as soot-free a manner as possible, and at high rotational speeds. As a fuel, it is sought to use liquid fuels, in particular gasoline, diesel, alcohol, liquefied petroleum gas and similar fuels. It is also sought to improve the ease of maintenance of the engine cylinder.

Said aims are achieved, in the case of a method of the type specified in the introduction, by means of the claimed features. It is provided according to the invention that the fuel is introduced into at least one, in particular one or two ignition paths preferably situated in the central region of the piston crown, and is ignited there in the ignition path formed by two ignition electrodes.

In the case of an engine cylinder according to the invention, it is provided according to the invention that the piston or the piston crown bears or has, at the combustion chamber side, at least one ignition path which comprises two ignition electrodes and the supply lines of which are guided to the piston circumference, and that wall electrodes are situated on the inner wall surface of the cylinder, and at those ends of the supply lines which are situated in the region of the piston circumference, radially opposite the wall electrodes, there are situated end electrodes for forming a spark path and/or an electric arc path.

The invention also relates to an engine and to an opposed-piston engine which are equipped with an engine cylinder according to the invention.

For the ignition, it is advantageous if the one or more ignition sparks for the ignition of the fuel-air mixture are maintained until the mixture has ignited. For the ignition, it is also advantageous if a plurality of ignition sparks are ignited at intervals of 0.3° to 0.8°, preferably 0.4° to 0.6°, crank angle. It is furthermore expedient if the total spark duration of the one or more ignition sparks is set to 0.2 to 1.0 ms, preferably 0.3 to 0.8 ms.

If diesel fuel is used, it is expedient if, during the injection of diesel fuel, the droplet cloud arriving at the ignition path is pre-evaporated or evaporated by means of at least one electric arc formed in the ignition path.

High-efficiency combustion is attained if the electric arc and/or the ignition sparks are ignited between two ignition electrodes borne by the piston arranged in the cylinder. It is advantageous here if the primary evaporation of the diesel droplets and/or the ignition of the fuel vapor takes place in the region close to the piston crown, centrally or around the longitudinal axis of the piston arranged in the cylinder.

For construction and operation, it is advantageous for the supply lines to be guided in a concealed fashion in the piston crown and bear or form the ignition electrodes at their end regions which emerge in the central region, or in the region close to the central point, of the piston. It may be provided here that the supply lines are arranged in the piston crown so as to be insulated in a voltage-proof manner and/or are guided by a surrounding insulator and/or insulators are inserted into the cylinder wall, by means of which insulators the wall electrodes are guided in an insulated manner with respect to the cylinder wall.

For the combustion, it is advantageous for the at least one ignition path to be arranged in a preferably diametrically running depression, in particular in a transversely running fashion, in the piston. The combustion and efficiency are improved if, during the injection of fuel, the main injection direction of the jets discharged by the feed unit runs parallel to the longitudinal direction of the depression, and/or if the main injection direction of the jets encloses a right angle with the ignition path, or if a multiplicity of ignition paths are provided, encloses an angle of 60° to 90° with the individual ignition electrodes or the supply lines thereof.

With regard to construction and for the electrical construction of the cylinder, it is advantageous if recesses which surround in each case the wall electrodes and the end electrodes are formed in the cylinder inner wall and/or in the running surface of the piston, and/or the wall electrodes are inserted into or connected to a carrier pin which extends through the cylinder wall.

It is expedient for the feed unit to be arranged in a cylinder head which closes off the cylinder.

In an opposed-piston engine according to the invention, it is provided that the pistons are driven opposingly and the introduction of fuel or of a fuel-air mixture, in particular the injection of a diesel-air mixture, takes place in the region of the central plane of the common cylinder which is formed by two cylinders.

Other features which are considered as characteristic for the invention are set forth in the appended claims.

Although the invention is illustrated and described herein as embodied in a central ignition spark position, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

BRIEF DESCRIPTION OF THE SEVERAL VIEWS OF THE DRAWING

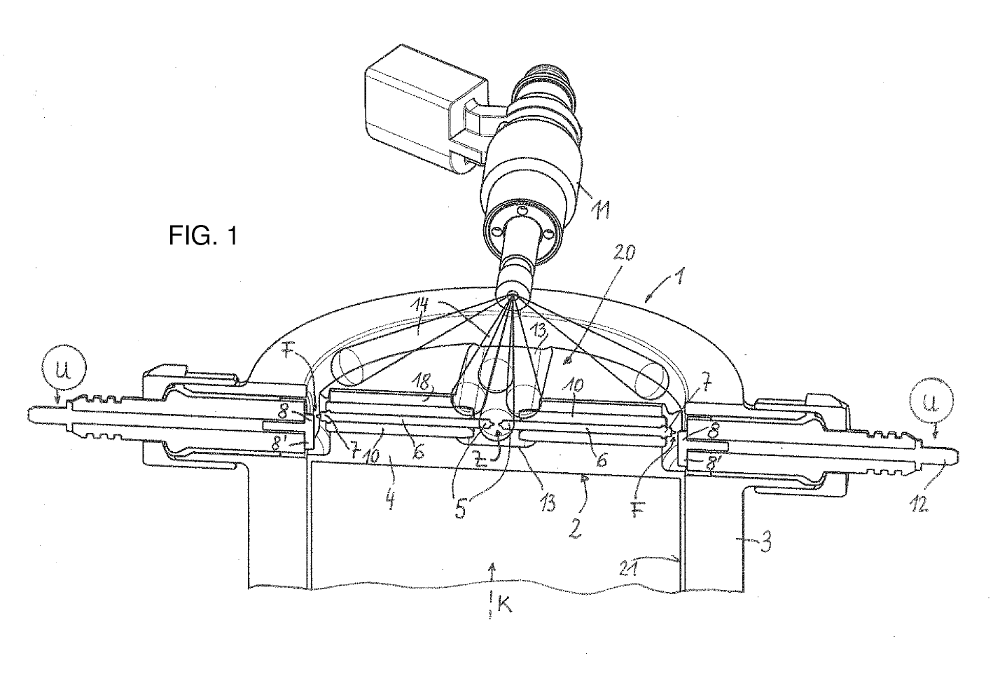

FIG. 1 shows a perspective section through a cylinder upper part with piston.

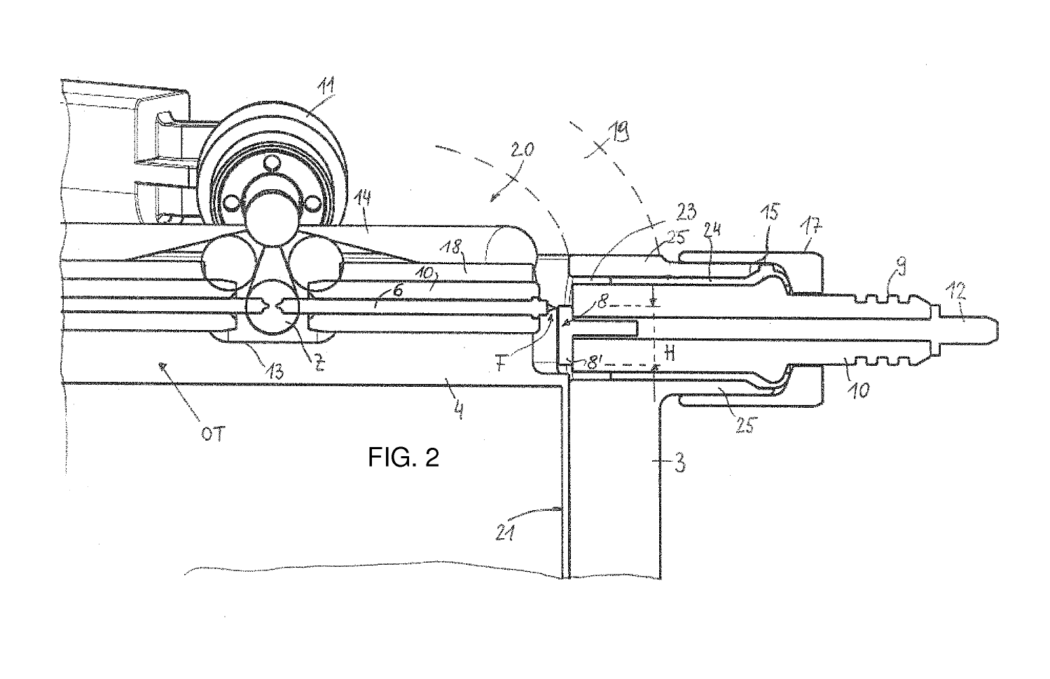

FIG. 2 shows a detail section in an enlarged view as per FIG. 1.

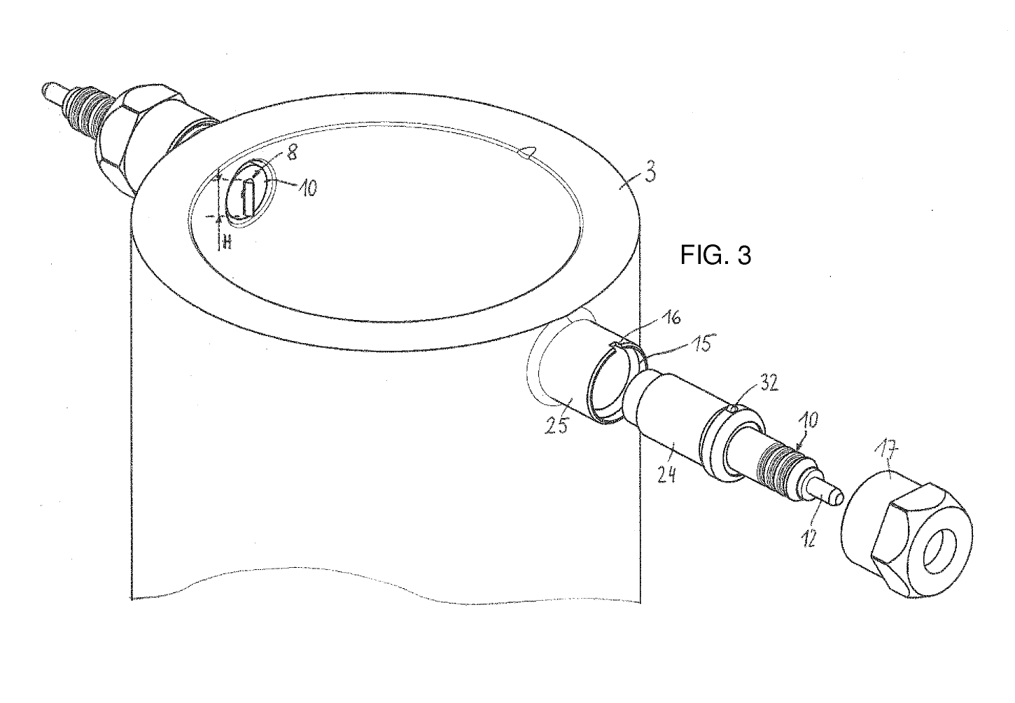

FIG. 3 shows a cylinder and wall electrodes inserted into the wall thereof.

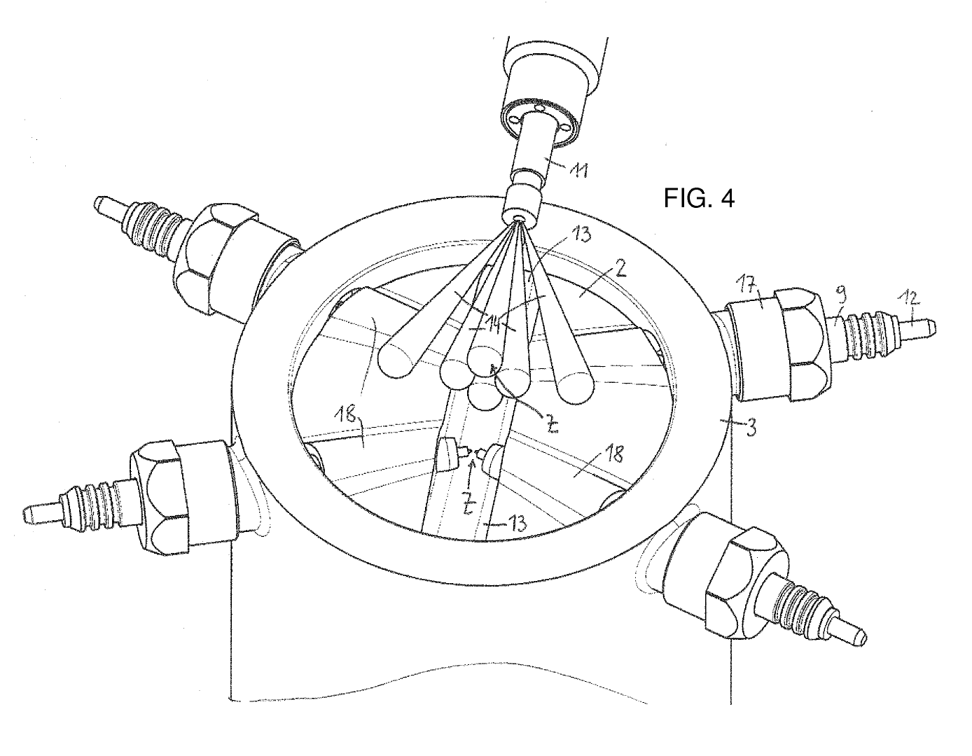

FIG. 4 shows a piston with two ignition paths.

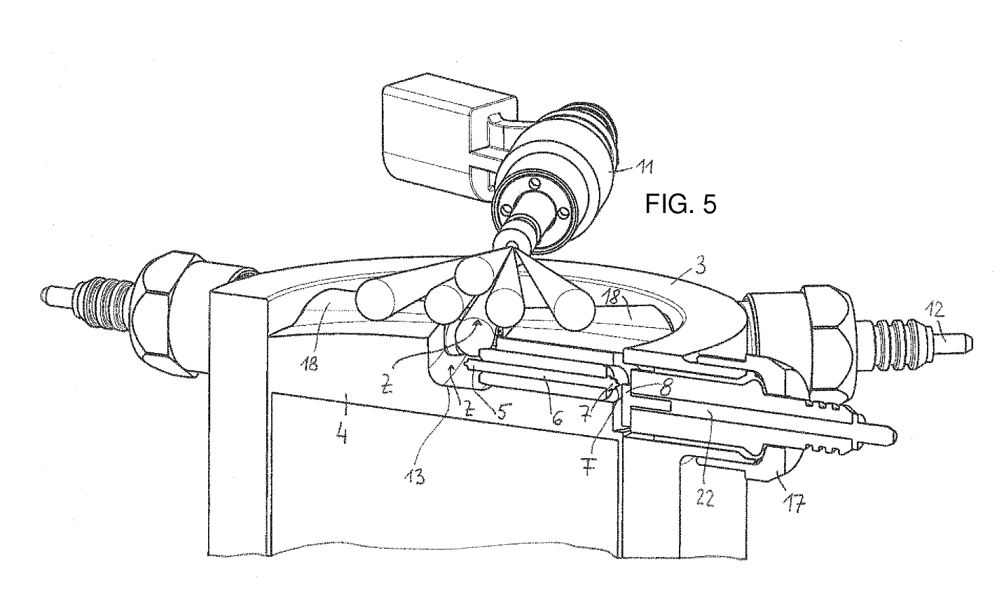

FIG. 5 shows a perspective section through a cylinder as per FIG. 4.

### DETAILED DESCRIPTION OF THE INVENTION

FIG. 1 shows an engine cylinder 1 according to the invention in which a piston 2 is mounted such that it can move up and down. In FIG. 1 and in FIGS. 2, 4 and 5, the piston 2 is illustrated in each case in its top dead center position.

The cylinder 1 can be closed off by means of a cylinder head 19 as is schematically illustrated in FIG. 2. In said cylinder head 19 there is arranged at least one feed unit 11 for fuel or for a fuel-air mixture, for example an injection unit 11. By means of said feed unit 11, fuel or a premixed fuel-air mixture is introduced in the form of fuel jets 14 into the engine cylinder 1.

The piston 2 bears, at the combustion chamber side, an ignition path Z which is formed by two ignition electrodes. Each ignition electrode 5 is connected in each case via a supply line 6 to an end electrode 7. When the piston 2 is situated in the region of top dead center, over a certain crank angle range, each end electrode 7 is situated opposite in each case one wall electrode 8 arranged in the cylinder wall 3. During the time period in which the end electrode 7 is situated opposite the wall electrode 8 during the movement of the piston 2, a predefined voltage of a voltage source U can be applied via a current feed line or a voltage terminal 12 to the ignition path Z or to the spark path F between the respective end electrode 7 and the wall electrode 8. The current required for generating an electric arc or at least one ignition spark in the ignition path Z between the ignition electrodes 5, or the voltage required for this purpose, is transmitted across said air path between the end electrode 7 and the wall electrode 8. The ignition path Z can thus ignite only when the wall electrodes 8 and the two end electrodes 7 are situated opposite one another. It is correspondingly provided that the wall electrodes 8 have, in the top dead center region of the piston 2, an electrode portion 8′ which extends in the piston longitudinal direction or parallel to a generatrix of the cylinder inner wall at least over a length corresponding to a crank position of 290° to 360°, and over said length region, form a spark path F with the respective opposing end electrode 7 borne by the piston 2. It can be seen from FIG. 2 that the wall electrodes 8 or the electrode portion 8′ thereof extend over a height region H which corresponds at least to the crank angle range predefined for the ignition of the fuel-air mixture and for the evaporation of the fuel droplets.

The ignition electrodes 5 are arranged in a recessed or covered manner in the piston 2. For this purpose, there is formed in the piston crown 4 a depression 13 which extends in the direction in which the fuel feed unit 11, which is if appropriate formed by an injection unit, introduces the major part of the fuel-air mixture into the combustion chamber of the cylinder 1. As illustrated in FIG. 1, the main jet of the fuel droplets is introduced or injected in the direction of the ignition path Z in the direction of the profile of the depression 13, while yet further secondary jets are injected into side regions of the combustion chamber. It is possible for a multiplicity of feed devices 11 to be provided which all inject the major part of the fuel-air mixture toward the ignition path or into the depression or into the piston cavity 13. It is expedient for 30 to 70% of the fuel, in particular diesel fuel, introduced to be introduced in the direction of the ignition path Z, and for the rest of the fuel to be introduced in such a way as to arrive at the ignition path Z at the ignition time.

It is provided that the supply lines 6 are guided in a concealed fashion in the piston crown 4 or under covers 18 of the piston crown 4 and bear or form ignition electrodes 5 at their end regions which emerge in the central region, or in the region close to the central point, of the piston crown 4, which ignition electrodes preferably project into the depression 13.

As illustrated in FIG. 5, it is possible for the supply line 6 which runs in the piston crown 4, the central electrodes 5 and the end electrodes to be formed in the manner of a continuous metal pin, which in its two end regions bears if appropriate electrode material or high-grade metal alloys produced in particular with iridium, platinum.

It can be seen from FIG. 2 that the wall electrode 8 is connected to or inserted into a pin-shaped voltage terminal 12, wherein the voltage terminal 12 is surrounded by an insulator 10. In this way, an ignition plug 9 is created which is inserted into a recess 23 in the cylinder wall 3. The ignition plugs 9 and/or the supply lines 6 lie in a plane which is perpendicular to the piston longitudinal axis K. An inclination of the spark plug 9 and/or of the supply lines 6 upward or downward relative to said plane by up to 7°, preferably by up to 5°, is possible. The interference fit of the spark plugs and of the supply lines is thus not impaired by the cylinder and piston movements. The spark plug 9 may be inserted against a sealing seat cone 15 using an insulator enclosure 24 and a sleeve nut 17, which sleeve nut 17 can be screwed onto a projection 25 which surrounds or partially forms the recess 23.

It can be seen from FIG. 3 that the projection 25 has an index groove 16 into which an index lug 32 borne by the insulator 10, or by the insulator enclosure 24 surrounding the insulator 10, can be inserted.

FIGS. 4 and 5 show the formation of two ignition paths Z in the piston 2. A corresponding number of ignition plugs 9 and of wall electrodes 8 is inserted into the cylinder wall 3. The two ignition paths Z lie in the depression 13, and the at least one fuel feed 11 discharges the major part of the fuel to be introduced into the depression 13 in the direction of the two ignition paths Z.

It may be provided that, for the evaporation of the supplied fuel droplets, the ignition path Z is connected to a high-voltage capacitor ignition unit, and for the supply of voltage to the ignition path Z for generating the one or more ignition sparks, the ignition path is connected to a battery ignition unit U which is combined with the high-voltage capacitor ignition unit.

The spacing between the end electrode 7 and the wall electrode 8 amounts to 0.2 to 1.0 mm.

During operation, at least a major part of the fuel, if appropriate all of the fuel, is introduced immediately before the ignition time in the form of fuel droplets with a mean Sauter diameter of ≦20 μm, preferably ≦10 μm, in the direction of the ignition path Z.

Fuel droplets of diesel, for example, injected into the ignition path Z can be evaporated by means of an electric arc formed in said ignition path Z, that is to say by means of a slightly longer-lasting ignition spark, and the vapor obtained as a result is ignited by means of one or a number of successive ignition sparks. The one or more ignition sparks for the ignition of the vapor-air mixture are maintained until the mixture has ignited.

For the compression ratio of the fuel-air mixture, it is provided that, in particular if diesel is used, the compression ratio V of the mixture is selected to be sufficiently low, preferably in the range 11:1≧V≧5:1, that auto-ignition of the mixture is prevented.

With the provided voltage supply which is connected to the voltage terminals 12, 300 to 1500 mJ, preferably 400 to 1200 mJ of energy is imparted to the one or more ignition sparks. The level of the breakthrough voltage for the one or more ignition sparks is selected to be 25 to 50 kV, preferably 30 to 45 kV.

The total spark duration of the one or more ignition sparks is set to 0.2 to 1.0 ms. It is provided that the injection of the fuel-air mixture into the combustion chamber 20 of the cylinder 1 takes place at a crank position of 260° to 340°, preferably 300° to 330°, crank angle, that is to say 100° to 20°, preferably 60° to 30°, before top dead center.

The ignition path Z or plurality of ignition paths Z lie centrally close to the piston longitudinal axis or close to the central region of the piston 2. If a single ignition path Z is provided, this is situated in or very close to the center of the piston; if two ignition paths are provided, these are situated with a spacing from the piston longitudinal axis which amounts to less than 30% of the piston radius.

In each case one cylinder according to the invention can form one of the two cylinders of an opposed-piston engine. For this purpose, it is also provided that the pistons 2 are driven opposingly and the feed of the fuel takes place in the region of the central plane of the cylinder 1. The walls of the two cylinders according to the invention may be combined to form a continuous or connected cylinder wall 3.

1. A method for the combustion of a fuel-air mixture present in the combustion chamber of an engine cylinder, the method comprising:
introducing at least a part of the fuel, in particular all of the fuel, immediately before the ignition time with a mean fuel droplet size of ≦20 μm, preferably ≦10 μm, as defined by the mean Sauter diameter, in a direction of at least one ignition path, and igniting the fuel-air mixture by one or a plurality of successive ignition sparks;
wherein the fuel is introduced into at least one, in particular one or two ignition paths preferably situated in the central region of the piston crown, and is ignited there in the ignition path formed by two ignition electrodes.

2. The method as claimed in claim 1, wherein the one or more ignition sparks for the ignition of the fuel-air mixture are maintained until the mixture has ignited.

3. The method as claimed in claim 1, wherein the compression ratio V of the diesel-air mixture is selected to be sufficiently low, preferably in the range 11:1≧V≧5:1, that auto-ignition of the mixture is prevented.

4. The method as claimed in claim 1, wherein the level of the breakthrough voltage for the one or more ignition sparks is selected to be 25 to 55 kV, preferably 30 to 50 kV, and/or in that 300 to 1500 mJ, preferably 400 to 1200 mJ of energy is imparted to the one or more ignition sparks, and/or in that a plurality of ignition sparks are ignited at intervals of 0.3° to 0.8°, preferably 0.4° to 0.6°, crank angle.

5. The method as claimed in claim 1, wherein the total spark duration of the one or more ignition sparks is set to 0.2 to 1.0 ms, preferably 0.3 to 0.8 ms.

6. The method as claimed in claim 1, wherein the injection of the fuel-air mixture into the combustion chamber of the cylinder takes place at a crank position of 260° to 340°, preferably 300° to 330°, crank angle, that is to say 100° to 20°, preferably 60° to 30°, before top dead center.

7. The method as claimed in claim 1, wherein 30 to 70% of the fuel, in particular diesel fuel, introduced is introduced in the direction of the ignition path, and the rest of the fuel is introduced in such a way as to arrive at the ignition path at the ignition time.

8. The method as claimed in claim 1, wherein, during the injection of fuel, preferably diesel, the droplet cloud arriving at the ignition path is pre-evaporated or evaporated by means of at least one electric arc formed in the ignition path.

9. The method as claimed in claim 1, wherein the electric arc and/or the ignition sparks are ignited between two ignition electrodes borne by the piston arranged in the cylinder.

10. The method as claimed in claim 1, wherein the primary evaporation of the fuel droplets and/or the ignition of the fuel vapor takes place in the region close to the piston crown, centrally and/or around the longitudinal axis of the piston arranged in the cylinder.

11. An engine cylinder having a piston and having at least one feed unit for introducing fuel or a fuel-air mixture into a combustion chamber of the cylinder, which comprises:
a piston crown bearing, in a central region thereof and at the combustion chamber side, at least one ignition path which comprises two ignition electrodes and the supply lines of which are guided to the piston circumference; and
wall electrodes situated on an inner wall surface of the cylinder, and at those ends of the supply lines which are situated in a region of the piston circumference, radially opposite the wall electrodes, there are situated end electrodes for forming a spark path or an electric arc path, via which end electrodes the ignition current is conducted to the spark path.

12. The cylinder as claimed in claim 11, wherein the supply lines are guided in a concealed fashion in the piston crown and bear or form the ignition electrodes at their end regions which emerge in the central region, or in the region close to the central point, of the piston.

13. The cylinder as claimed in claim 11, wherein the wall electrodes have, in the top dead center region of the piston, an electrode portion which extends in the piston longitudinal direction or parallel to a generatrix of the cylinder inner wall at least over a length corresponding to a crank position of 290° to 360°, and over said length region, form a spark path or electric arc path with the respective opposing end electrode borne by the piston.

14. The cylinder as claimed in claim 11, wherein the supply lines are arranged in an electrically insulated manner with an interference fit in the piston crown, and are guided by a surrounding insulator which is inserted with an interference fit.

15. The cylinder as claimed in claim 11, wherein insulators are inserted in the cylinder wall, by means of which insulators the wall electrodes are guided in an insulated manner with respect to the cylinder wall.

16. The cylinder as claimed in claim 11, wherein the at least one ignition path is arranged in a preferably diametrically running depression, in particular in a transversely running fashion, in the piston.

17. The cylinder as claimed in claim 11, wherein, during the injection of fuel, the main injection direction of the jets discharged by the feed unit runs parallel to the longitudinal direction of the depression, and/or in that the main injection direction of the jets encloses a right angle with the ignition path, or if a multiplicity of ignition paths are provided, encloses an angle of 60° to 90° with the individual ignition electrodes or the supply lines thereof.

18. The cylinder as claimed in claim 11, wherein recesses which surround in each case the wall electrodes and the end electrodes are formed in the cylinder inner wall and/or in the running surface of the piston.

19. The cylinder as claimed in claim 11, wherein the supply line which runs in the piston crown, the central electrode and the end electrode are formed in the manner of a preferably continuous metal pin, which in its two end regions bears if appropriate an iridium-based and/or platinum-based electrode material or high-grade metal alloys.

20. The cylinder as claimed in claim 11, wherein the wall electrode is inserted in or connected to a carrier pin which extends through the cylinder wall.

21. The cylinder as claimed in claim 11, wherein the feed unit is arranged in a cylinder head which closes off the cylinder.

22. The cylinder as claimed in claim 11, wherein, for the evaporation of the supplied fuel droplets, the ignition path is connected to a high-voltage capacitor ignition unit, and for the supply of voltage to the ignition path for generating the one or more ignition sparks, the ignition path is connected to a battery ignition unit which is combined with the high-voltage capacitor ignition unit.

23. The cylinder as claimed in claim 11, wherein the spacing between the end electrode and the portion of the wall electrode amounts to 0.2 to 1.0 mm.

24. The cylinder as claimed in claim 11, wherein the ignition plugs and/or the supply lines lie in a plane which runs perpendicular to the piston longitudinal axis, or in that the ignition plugs and/or the supply lines enclose an angle of at most 7°, preferably at most 5°, with said plane.

25. An engine, comprising at least one cylinder according to claim 11.

26. An opposed-piston engine, comprising: two engine cylinders according to claim 11 connected to form a common cylinder, in which the pistons are driven opposingly and the introduction of fuel or of a fuel-air mixture, in particular the injection of a diesel-air mixture, takes place in the region of the central plane of the common cylinder.
